(19) United States
(12) Patent Application Publication
(10) Pub. No.: US 2007/0112956 A1
(43) Pub. Date: May 17, 2007

(54) RESOURCE OPTIMISATION COMPONENT

(76) Inventors: Matthew Paul Chapman, Eastleigh (GB); Matthew Alexander Webster, Hook (GB)

Correspondence Address: IBM CORPORATION;INTELLECTUAL PROPERTY LAW, 11400 BURNET ROAD, AUSTIN, TX, 78758, US

(21) Appl. No.: 11/539,765

(22) Filed: Oct. 9, 2006

(30) Foreign Application Priority Data
Nov. 12, 2005 (GB) 0523115.4

(51) Int. Cl. G06F 15/173

(52) U.S. Cl. 709/224

(57) ABSTRACT

A resource optimisation component for optimising the performance of a process operating in a data processing system, the resource optimisation component comprising: a monitoring component for gathering performance statistics about a process and identifying a resource that has an effect on process performance; a throttling component for restricting the available capacity of the identified resource; and wherein the monitoring component monitors process performance to determine the effect of the restriction in the available capacity of the identified resource on the process performance, and identifies an action to be performed to the resource in order to improve the process performance.

### FIELD OF THE INVENTION

The invention relates to the field of resource management. In particular the invention relates to resource optimisation in a data processing system.

### BACKGROUND OF THE INVENTION

Computer systems are expected to perform many different tasks. These tasks vary from processing complex calculations, playing CPU intensive gaming applications to word processing applications etc. Even in the most basic computer systems a large number of finite resources, for example, CPU memory, storage means and network bandwidth, are utilised by many applications at the same time. All of these finite resources have an effect on the performance of applications running on the computer system.

In order to increase throughput or reduce response times of applications or processes running on a computer system it is usual to try to increase the capacity of one or more resources. However, choosing which resource is a non-trivial task. One known approach is to choose the resource which is operating at full capacity. However, this is difficult to determine in the case of virtual memory or in the case of heterogeneous workloads where one or more resources regularly reach full operating capacity.

Selectively upgrading such resources and measuring for performance improvements typically requires the computer system to be stopped and restarted, which can be expensive, be time consuming or cause an unacceptable interruption to service. In a server installation it may be possible to move workload between different systems to improve performance but this approach does not work for standalone personal computers and isolated machines such as routers or switches.

Thus there is a need in the art to identify which resources have the most effect on an application or process running on a computer system and in turn which of the identified resources would benefit from an increase in capacity thereby improving the performance of the application or process.

### SUMMARY OF THE INVENTION

Viewed from a first aspect, the present invention provides a resource optimisation component for optimising the performance of a process operating in a data processing system, the resource optimisation component comprising: a monitoring component for gathering performance statistics about a process and identifying a resource that has an effect on process performance; a throttling component for restricting the available capacity of the identified resource; and wherein the monitoring component monitors process performance to determine the effect of the restriction in the available capacity of the identified resource on the process performance, and identifies an action to be performed to the resource in order to improve the process performance.

Viewed from a second aspect, the present invention provides a resource optimisation method for optimising the performance of a process operating in a data processing system, the resource optimisation method comprising the steps of: gathering performance statistics about a process and identifying a resource that has an effect on the process's performance; restricting the available capacity of the identified resource by a throttling component; and monitoring the process performance to determine the effect of the restriction in the available capacity of the identified resource on the process performance, and identifying an action to be performed to the resource in order to improve process performance.

Viewed from a third aspect, the present invention provides a computer program product directly loadable into the internal memory of a digital computer, comprising software code portions for performing as described above when said product is run on a computer.

The present invention advantageously provides for the identification of resources which have an effect on application or process performance and, for each of the determined resources determining which of the resources would benefit from an increase in operational capacity—thereby improving the performance application or process performance.

For example, the resource optimisation component may detect a CPU as having an effect on an application's performance and as a consequence restricts the CPU's available operating capacity by a particular percentage, for example, 10%. The resource optimisation component monitors process performance in light of the restriction in the CPU's operating capacity.

Depending on the severity of the effect the resource optimisation component makes suggestions to the user or to the operating system about actions that could be performed in order to improve the process performance. An action maybe to replace the CPU with a faster and more efficient CPU or increase memory size etc.

It may be that a reduction in CPU resource has no significant effect on the process performance and therefore no suggestion will be given. But the resource optimisation component may detect that a reduction of the available capacity of another type of resource does cause a significant effect and thus actions will be suggested for improving the process performance in response to the other type of detected resource.

Thus advantageously, the resource optimisation component continually monitors applications and/or processes running on the computer systen detecting bottle necks in the performance of applications and processes. Further, because the resource optimisation component detects bottleneck by decreasing resource capacity it is possible to more accurately detect where bottlenecks are located in the computer system with out having to go to the expense of trial and error of replacing components to determine which replacement derives the greatest benefit.

### BRIEF DESCRIPTION OF THE DRAWINGS

Embodiments of the invention are described below in detail, by way of example only, with reference to the accompanying drawings in which:

FIG. 1 shows a data processing system in which the present invention may be embodied;

FIG. 2 is a block diagram illustrating the components of the resource optimisation component in accordance with a preferred embodiment of the invention;

FIG. 3 is a block diagram showing the internal components of the monitoring component in accordance with a preferred embodiment of the invention;

FIG. 4 is a flow chart illustrating the operation steps of the resource optimisation component in accordance with a preferred embodiment of the invention;

FIG. 5 is a sequence diagram showing the sequence steps of the resource optimisation component when operating in a passive mode in accordance with a preferred embodiment of the invention; and

FIG. 6 is a sequence diagram showing the sequence steps of the resource optimisation component when operating in an active mode in accordance with a preferred embodiment of the invention.

### DETAILED DESCRIPTION OF THE INVENTION

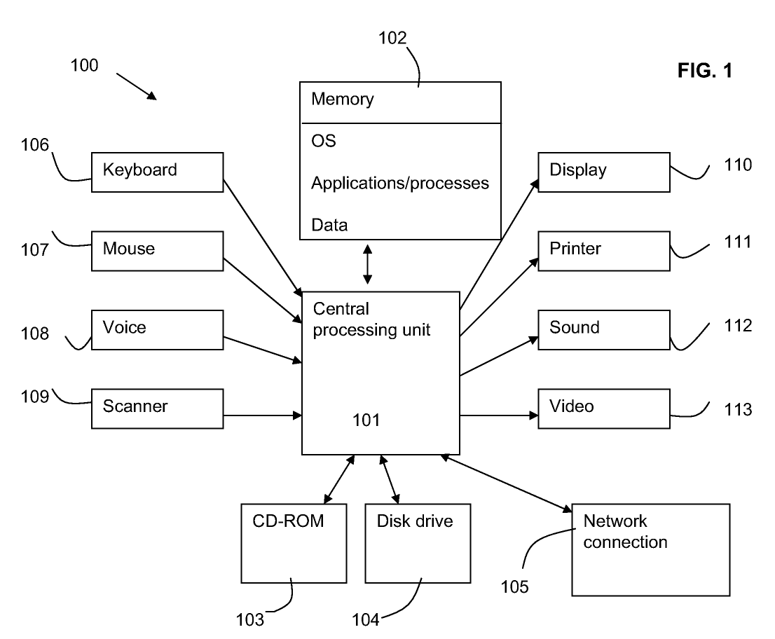

Referring to FIG. 1, a computer system 100 is shown in which a preferred embodiment of the present invention may be implemented. A computer system 100 has a central processing unit 101 with primary storage in the form of memory 102 (RAM and ROM). The memory 102 stores program information and data acted on or created by applications. The program information includes the operating system code for the computer system 100 and application code for applications running on the computer system 100. Secondary storage includes optical disk storage 103 and magnetic disk storage 104. Data and program information can also be stored and accessed from the secondary storage.

The computer system 100 includes a network connection means 105 for interfacing the computer system 100 to a network such as a local area network (LAN) or the Internet. The computer system 100 may also have other external source communication means such as a fax modem or telephone connection.

The central processing unit 101 comprises inputs in the form of, as examples, a keyboard 106, a mouse 107, voice input 108, and a scanner 109 for inputting text, images, graphics or the like. Outputs from the central processing unit 101 may include a display means 110, a printer 111, sound output 112, video output 113, etc.

In a distributed system, a computer system 100 as shown in FIG. 1 may he connected via a network connection 105 to a server on which applications may be run remotely from the central processing unit 101 which is then referred to as a client/server system.

Applications may run on the computer systems 100 from a storage means 103, 104 or via a network connection 105 which may include spread sheet applications, database applications and other storage and retrieval mechanisms.

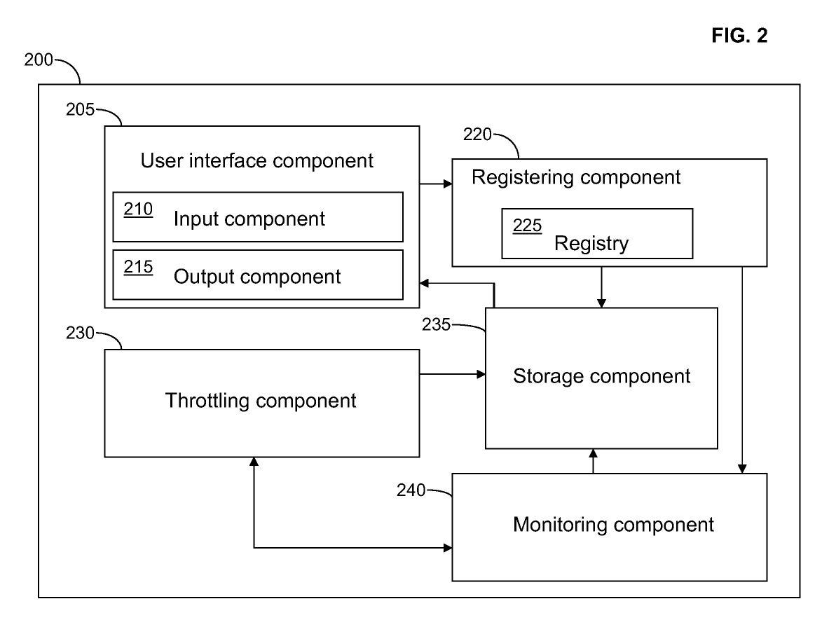

FIG. 2 illustrates the components of a preferred embodiment of the present invention. The invention provides an enhancement to current resource management tools in the form of a resource optimisation component 200. The resource optimisation component 200 runs on the computer system 100 or from other computer systems accessed across network means 105. The resource optimisation component 200 provides means for measuring the performance of an application in response to a reduction in the resource's available operating capacity and detects whether the application's performance is effected by the reduction of resource's available operating capacity. If the application's performance is effected by the reduction in resource, the resource optimisation component 200 assumes that the same application's performance will respond to an increase in the available operating capacity of the one or more resources. Thus, the application's performance can be fine tuned by allowing the application to have access to more resources in areas where the resource optimisation component 200 detects it is required.

The resource optimisation component 200 comprises a number of subcomponents in order to achieve the function and benefits of the present invention. According to a preferred embodiment the resource optimisation component 200 comprises a user interface component 205 for data input and for displaying a number of performance statistics to a user, a registering component 220 for registering one or more applications or one or more processes which require their performance to be tuned, a monitoring component 240 for monitoring the resources associated with the registered applications and/or processes and a throttling component 230 for incrementally decreasing the available operating capacity of a resource. Each of these components will now be explained in turn.

The user interface component 205 comprises an input component 210 and an output component 215. The input component 210 comprises a user interface for allowing users to select applications to be monitored. The applications may comprise web browsers, database applications, spreadsheet applications, word processing applications, gaming applications etc, or processes which are used by the operating system in order to support the applications etc. For example, the list in example 1 illustrates a sample of the processes which are active when the operating system is running and a minimum set of applications are loaded, such as a presentation software and a word processing application.

### EXAMPLE 1

Skmaild.exe

Abti2evxx.exe

Bttray.exe

Adnetsvr.exe

qttask.exe

taskmgr.exe

smss.exe

qconsvc.exe

defwatch.exe

system.exe

system idle process.exe

The input interface 205 displays to the user a list of the applications that are installed on the computer system 100. For each application displayed in the list, a further list is displayed detailing each of the processes associated with the application. For example, if the application running on the computer system is, for example, presentation software the processes associated with the presentation may be pres.exe and sys.exe etc.

The user may select which applications or processes are to be monitored by a variety of input means, for example, using a mouse 107 to select an application or process from the list or by using shortcut keys on a keyboard 106.

On selection of the applications or processes the user is prompted to enter further information such as, any further restrictions to be placed on resources. For example, if increasing access to more memory is not feasible, the user may deselect this option. Thus, preventing the resource optimisation component 200 displaying a set of results which might suggest adding more memory.

For clarity, the rest of this document will refer to the terms process or processes which are to be read to encompass terms such as applications running on the computer system 100 and processes which are used by the operating system to support applications running on the computer system 100 and other processes interacting with the operating system.

The output component 215 displays statistical analysis computed by the monitoring component 240. The statistical analysis may be in the form of graphical charts and textual prompts suggesting to the user steps to be performed or actions the operating system could perform in order to fine tune the performance of the one or more processes. For example, a step to be performed by a user may be to install more memory or a higher capacity hard drive. Steps to be performed by the operating system may comprise increasing the amount of virtual memory an application has access too etc.

The input component 210 communicates the input data to the registration component 220. The registration component 220 registers the input data in its registry and transmits a notification to the storage component 235 to commit the input data to storage. The registry component 220 also detects whether any input data has already been stored about the process and if so sends a communication to the output component 215 asking the user whether the previously stored data should be overwritten or kept. If the previously stored data is to be retained, a new entry in the registry is created and the totality of the previously stored data and the new input data is used for statistical comparisons by the registering component 220.

The storage component 235 receives input from the registering component 235 and the throttling component 230. The storage component acts as a broker between the registering component 220, the throttling component 230 and the storage means to ensure the correct data is stored in the storage means and to perform general house keeping operations.

The monitoring component 240 receives instructions from the registering component 220. The instructions comprise the name of the processes which have been registered for monitoring and other information such as the length of time in which the registered processes should be monitored for.

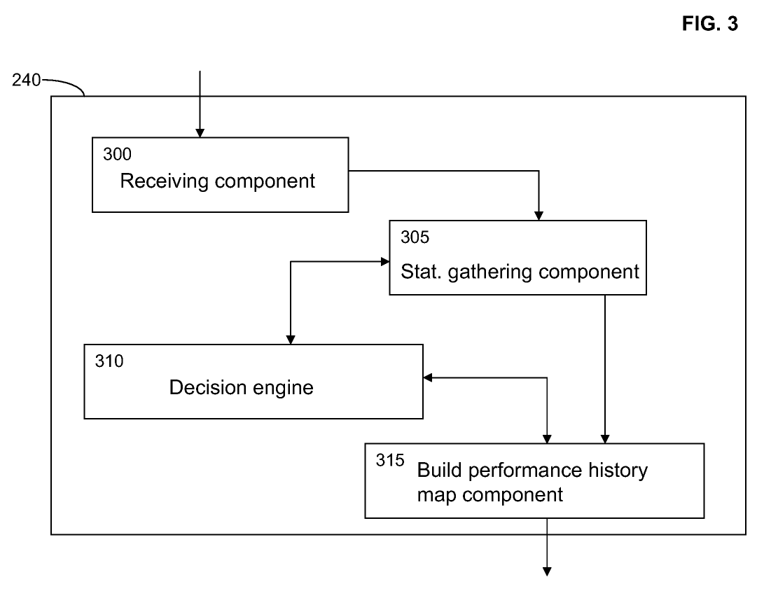

Referring to FIG. 3, the monitoring component 240 comprises a number of subcomponents which interact with each other to contribute to the function and benefit of the present invention. The monitoring component 240 comprises a receiving component 300 for receiving instructions from the registering component 220, a statistical gathering component 305 for monitoring the registered processes, a decision engine 310 for determining the effect a monitored resources has on a registered process and a build component 315 for building a performance history map detailing statistical information gathered by the monitoring component 240.

The statistical gathering component 305 deploys a number of mechanisms in which to provide the monitoring services. For example, the statistical gathering component 305 may utilise API calls for querying the CPU time and memory usage of a process, or ping commands and mobile agents, in order to measure the average response time of a web server.

The statistical gathering component 305 monitors the performance of the registered process over a predetermined period of time. The length of time the performance of the registered process is monitored for is dependent on the type of process being monitored. For example, if the monitored process is a web browser it is important to monitor the web browser's performance over a period of twenty four or forty eight hours. This is because it is important to take into account the fluctuations in network traffic and bandwidth congestion caused by environmental variables outside the control of the web browser. Thus if congestion in the network is causing a derogation in the web browser's performance increasing the amount of memory the web browser has access too will not help increase the web browser's performance.

The type of statistics gathered by the statistical gathering component 305 will also depend on the process being monitored, but typically, the statistics will be concerned with the response time of the process, for example, how long does it take for a web page to be loaded by the web browser or how long does it take for a gaming application to load graphics and compute gaming data before displaying the next scene etc.

The statistical gathering component 305 collects the statistical data and transmits the statistical data to the storage component 235 for storing in the storage means 103, 104. The statistical data forms a performance history map for each registered process and its associated resources.

An example of a performance history map is shown in example 2.

### EXAMPLE 2

| | |
|---|---|
| Registered process: | web server |
| Date: | 10/10/05 |
| Time: | 12:35 |
| Packets received: | 12467 |
| Packets sent: | 12460 |
| Packets Lost: | 7 |
| Average response time: | 30 ms |
| Date: | 11/10/05 |
| Time: | 12:55 |
| Packets received: | 15998 |
| Packets sent: | 15998 |
| Packets Lost: | 0 |
| Average response time: | 35 ms |

The decision engine 310 analyses the performance history map and determines which resources have the greatest effect on the registered process's performance. The decision engine 310 compiles a list of these resources and communicates the list to the throttling component 230.

Moving hack to FIG. 2, the throttling component 230 receives the list and for each process listed, restricts the amount of operating capacity available for a resource. For example, if under normal operating conditions a process has access to 100% of the resource's operational capacity, the throttling component may begin by restricting the amount of available operational capacity by 5%, 10% and so on. The restriction of resource capacity is achieved in a number of ways for example, by reserving a particular amount of resource for another process or blocking process access to a resource's allocated capacity. Other methods are known in the art and will not be discussed here further.

The throttling component 230 transmits a notification to the statistical gathering component 305 informing the statistical gathering component 305 of the restrictions applied to the resources associated with the listed processes.

The statistical gathering component 305 continues to monitor the performance of the process for a predetermined period of time in light of the restriction in resource capacity. Again statistical data, such as response time, is collected for each of the processes and appended to the historical performance data map.

On completion of the performance history map, the decision engine 310 parses the map to calculate the percentage change in performance for each process in light of the restriction in resource capacity. For example, restricting CPU resource by 10% resulted in a 5% reduction in performance of the registered process.

The decision engine 310 ranks the calculations in order of the percentage reduction for each registered process, for example, ranking the calculations by the highest value first. The decision engine 310 produces an output in the form of a report. The report lists the ranked calculations and also a number of actions that could be performed by the user in light of the calculations. For example, if the decision engine 310 calculated that restricting the CPU speed resulted in a 5% reduction in performance, the decision engine 310 may suggest the registered process be given access to more CPU resource.

The report is transmitted to the storage component 235 wherein the storage component 235 communicates the report to the user interface component 205 for displaying to the user.

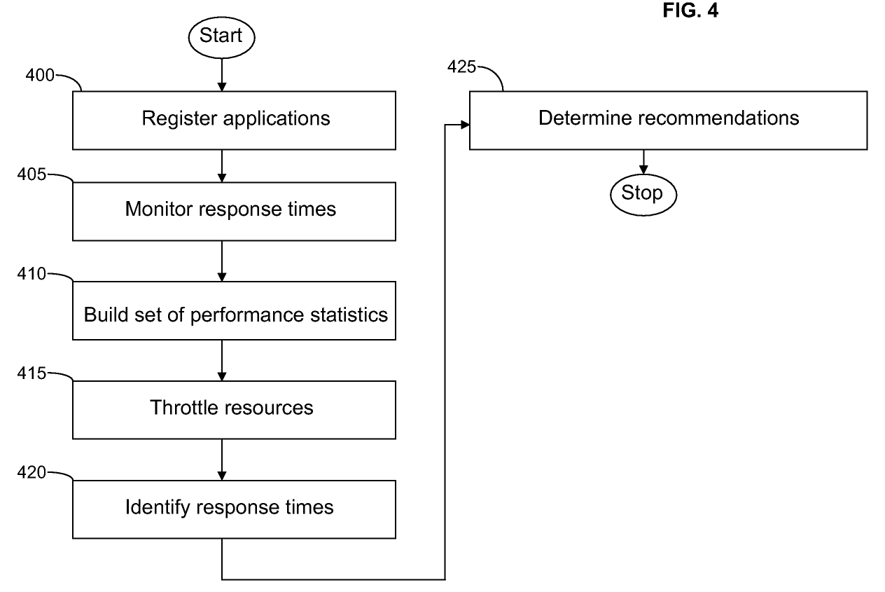

FIG. 4 is a flow chart detailing the operation steps of the invention in use. At step 400 the registering component 220 receives instructions from the input component 210 detailing which processes which have been selected to be monitored, for example, a database application and a web application. The output component 215 displays to the user the processes which have been selected.

At step 405, the monitoring component 240 begins to monitor the selected processes, for example, a database application and a web application. The selected processes may be monitored over a configurable time period, for example, monitoring performance over a 24 hour time period. It will be appreciated by a person skilled in the art that each selected process may be monitored over separate and differing time periods. The monitoring component 240 gathers statistical performance data pertaining to response times for each of the selected applications. The statistical performance data comprises data such as response times for computing data, CPU resources utilised and memory resources utilised.

At step 410, the monitoring component 240 transmits the performance data to the throttling component 230 and the throttling component 230 determines the percentage restriction in operational capacity for each identified resource, for example, restricting access to virtual memory by 30%. The throttling component 230 notifies the monitoring component 240 that restrictions have been placed on the identified resources.

At step 420, the monitoring component 240 monitors and gather performance related statistical information for each of the selected processes to determine response times in light of the restriction to resources. The performance data gathered is appended to the performance history map. On completion of the performance history map, at step 420, the monitoring component 240 parses the map to calculate the percentage change in performance for each selected process, for example, restricting CPU speed by 10% resulted in a 5% reduction in performance of the registered process. The monitoring component 240 ranks the calculations in order of the percentage change in performance for each registered resource. The monitoring component 240 produces an output in the form of a report. The report lists the ranked calculations and also a number of actions that could be performed by the user or the operating system, in light of the calculations, at step 425.

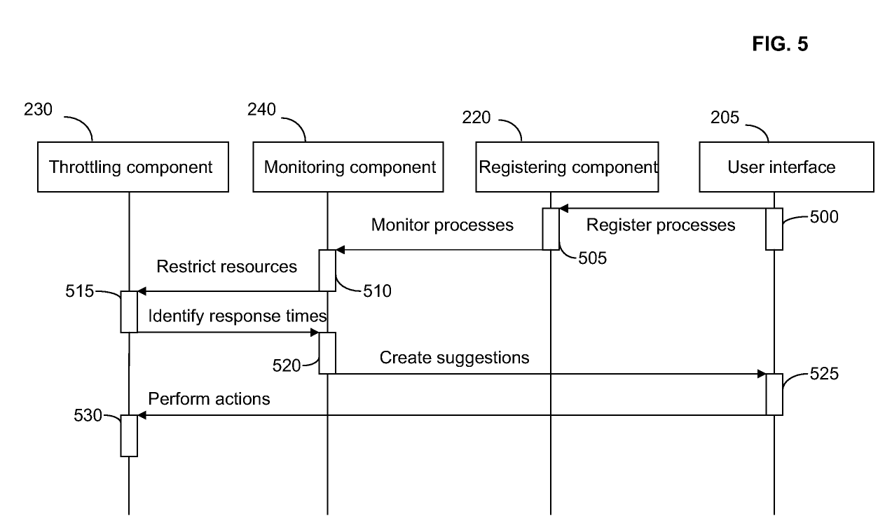

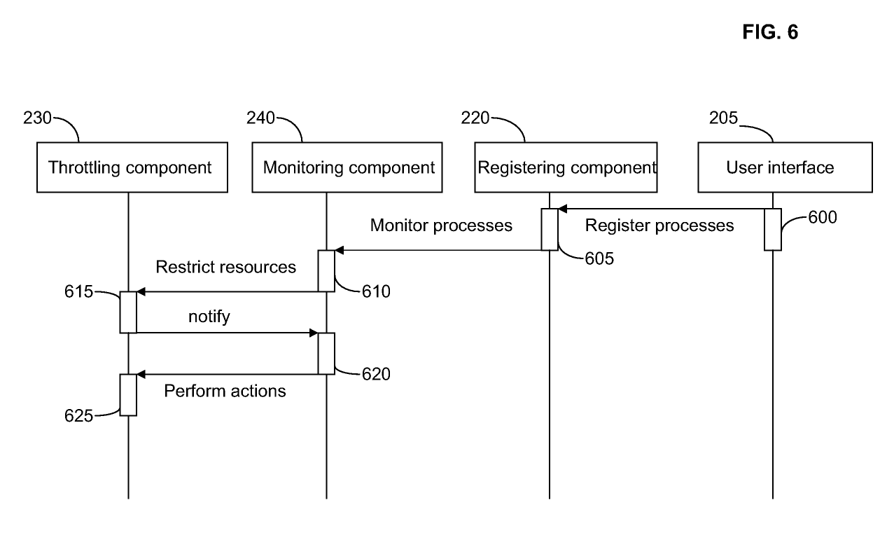

FIG. 5 and 6 are sequence diagrams showing the sequence of events that occur when the invention is in use. FIG. 5 shows the sequence of events when operating in an active mode i.e. requiring input from a user and FIG. 6 showing the sequence of events when operating in a passive mode i.e. when the operating system has primary control.

Referring, firstly, to FIG. 5 a user inputs data pertaining to the processes to be monitored into the user interface 205 at event 500. At event 505, the registering component 220 receives the data from the user interface 210 and notifies the monitoring component 240 to commence the monitoring and statistical gathering process at event 510. The monitoring component 240 determines which resources have the most effect on the selected processes and notifies the throttling component 230 at event 515 to restrict access to resource operational capacity. For example, restricting access to CPU resource by 5%, followed by 10%, followed by 15% and so on.

The monitoring component 240 identifies the percentage effect of the restriction of the resource. For example, the percentage effect of restricting access to CPU resource by 5%, 10% and 15% etc. The monitoring component 230 also determines a number of actions which could be performed in light of the monitoring component's 230 calculations at event 520. For example, increasing memory access by 15% or installing more memory in the computer system would yield a performance increase of 50% etc. The calculations and the suggestions are transmitted to the user interface component 205 for displaying to the user at event 205. The user may then, via the user interface 205, instruct the operating system to perform particular suggestions in order to optimise the selected processed performance at event 530.

Moving onto FIG. 6 a user inputs data pertaining to the processes to be monitored into the user interface 205 at event 600. At event 605, the registering component 220 receives the data from the user interface 210 and notifies the monitoring component 240 to commence the monitoring and statistical gathering process at event 610. The monitoring component 240 determines which resources have the most effect on the selected process and notifies the throttling component 230 at event 615 to restrict access to a portion of the resource's available operating capacity. For example, restricting access to CPU resource by 5%, followed by 10%, followed by 15% and so on.

The monitoring component 240 monitors the effect of the restriction in available operating capacity has an the monitored process. For example, the percentage effect of restricting access to CPU resource by 5%, 10% and 15% etc. The monitoring component also determines a number of actions which could be performed in light of the monitoring component's 240 calculations at event 620. For example, increase memory access by 15% or installing more memory in the computer system would yield a performance increase of 50% etc. In this example, the calculations and the suggestions are transmitted to the throttling component 625 for carrying out the suggestions on behalf of the operating system at event 625—thus continually optimising poor performing processes.

1. A resource optimisation component for optimising the performance of a process operating in a data processing system, the resource optimisation component comprising:
a monitoring component for gathering performance statistics about a process and identifying a resource that has an effect on process performance;
a throttling component for restricting the available capacity of the identified resource; and
wherein the monitoring component monitors process performance to determine the effect of the restriction in the available capacity of the identified resource on the process performance, and identifies an action to be performed to the resource in order to improve the process performance.

2. A performance optimisation component as claimed in claim 1 wherein the action to be performed is to increase the capacity of the identified resource beyond the available capacity of the resource.

3. A performance optimisation component as claimed in claim 1 wherein restricting the available capacity of the identified resource further comprises the throttling component incrementally decreasing the available capacity of the identified resource.

4. A performance optimisation component as claimed in claim 3 wherein for each incremental decrease, the monitoring component determines the effect on the process performance.

5. A performance optimisation component a claimed in claim 1 wherein the throttling component is operable to restrict the identified resource's capacity by blocking a process's access to an original allocated amount of resource.

6. A performance optimisation component as claimed in claim 4 wherein the monitoring component determines a severity of the effect on the process performance.

7. A performance optimisation component as claimed in claim 6 wherein depending on the severity of the effect, the monitoring component identifies a suitable action.

8. A resource optimisation method for optimising the performance of a process operating in a data processing system, the resource optimisation method comprising the steps of:
gathering performance statistics about a process and identifying a resource that has an effect on the process's performance;
restricting the available capacity of the identified resource by a throttling component; and
monitoring the process performance to determine the effect of the restriction in the available capacity of the identified resource on the process performance, and identifying an action to be performed to the resource in order to improve process performance.

9. A performance optimisation method as claimed in claim 8 wherein the action to be performed is to increase the capacity of the identified resource beyond the available capacity of the resource.

10. A performance optimisation method as claimed in claim 8 wherein restricting the available capacity of the identified resource further comprises the throttling component incrementally decreasing the available capacity of the resource.

11. A performance optimisation component as claimed in claim 10 wherein for each incremental decrease, determining the effect that the incremental decrease has on process performance.

12. A performance optimisation method a claimed in claim 8 wherein the restricting step further comprises blocking a process's access to its original allocated amount of resources.

13. A performance optimization method as claimed in claim 11 wherein the monitoring step further comprises determining the severity of the effect on process performance.

14. A performance optimisation method as claimed in claim 13 further comprises identifying a suitable action in dependence on the determined severity of the effect.

15. A computer program product comprising a storage-type computer usable medium including a computer readable program, wherein the computer readable program when loaded into the memory of a data processing system causes the data processing system to perform a resource optimization method for optimising the performance of a process operating in the data processing system, the resource optimisation method comprising:
gathering performance statistics about a process and identifying a resource that has an effect on the process's performance;
restricting the available capacity of the identified resource by a throttling component; and
monitoring the process performance to determine the effect of the restriction in the available capacity of the identified resource on the process performance, and identifying an action to be performed to the resource in order to improve process performance.

16. A program product as claimed in claim 15 wherein the action to be performed is to increase the capacity of the identified resource beyond the available capacity of the resource.

17. A program product as claimed in claim 15 wherein restricting the available capacity of the identified resource further comprises the throttling component incrementally decreasing the available capacity of the resource.

18. A program product as claimed in claim 17 wherein for each incremental decrease, determining the effect that the incremental decrease has on process performance.

19. A program product as claimed in claim 15 wherein the restricting step further comprises blocking a process's access to its original allocated amount of resources.

20. A program product as claimed in claim 18 wherein the monitoring step further comprises determining the severity of the effect on process performance.
